(19) United States
(12) Patent Application Publication
(10) Pub. No.: US 2011/0179778 A1
(43) Pub. Date: Jul. 28, 2011

(54) METHOD AND APPARATUS FOR EXHAUST GAS AFTERTREATMENT FROM AN INTERNAL COMBUSTION ENGINE

(75) Inventor: Russell P. Durrett, Bloomfield Hills, MI (US)

(73) Assignee: GM GLOBAL TECHNOLOGY OPERATIONS, INC., DETROIT, MI (US)

(21) Appl. No.: 12/694,346

(22) Filed: Jan. 27, 2010

(51) Int. Cl. F01N 3/10; B01D 53/94; B01D 53/22

(52) U.S. Cl. 60/299

(57) ABSTRACT

An apparatus has an internal combustion engine configured to operate at a lean air/fuel ratio and includes an exhaust aftertreatment system including an oxygen separator fluidly connected upstream of a three-way catalytic converter.

### TECHNICAL FIELD

This disclosure is related to exhaust aftertreatment systems for internal combustion engines.

### BACKGROUND

The statements in this section merely provide background information related to the present disclosure and may not constitute prior art.

Known combustion by-products in an exhaust gas feedstream include carbon monoxide (CO), oxides of nitrogen (NOx), and particulate matter (PM), and others. Unburned hydrocarbons (HC) and oxygen (O₂) are also present in engine-out emissions. Operating the engine at varying air/fuel ratios, including rich, lean and stoichiometric ratios, produce different proportions of the combustion by-products, HCs, and oxygen. NOx is created by nitrogen and oxygen molecules present in engine intake air disassociating in the high temperatures of combustion, and rates of NOx creation follow known relationships to the combustion process, for example, with higher rates of NOx creation being associated with higher combustion temperatures and longer exposure of air molecules to the higher temperatures. NOx molecules, once created in the combustion chamber, can be reduced back into nitrogen and oxygen molecules in known catalytic devices.

Multiple engine operating strategies and aftertreatment devices have been used to reduce combustion by-products including NOx emissions in the exhaust gas feedstream.

One exemplary aftertreatment device for reducing NOx emission is a selective catalytic reduction device (SCR). Known SCR devices utilize ammonia derived from urea injection to react with NOx. Ammonia stored on a catalyst bed within the SCR reacts with NOx, preferably NO₂, and produces favorable reactions to reduce the NOx. It is known to operate a diesel oxidation catalyst (DOC) upstream of the SCR in diesel applications to convert NO into NO₂ prior to reducing it in the SCR.

Another aftertreatment device is a NOx trap device. The NOx trap device utilizes catalysts capable of storing some amount of NOx for subsequent reduction. Engine control technologies have been developed to combine these NOx traps or NOx adsorbers with fuel efficient engine control strategies to improve fuel efficiency and still achieve acceptable levels of NOx emissions. One control strategy includes using a lean NOx trap to store NOx emissions during lean engine operation and then purging the stored NOx during rich engine operation, with higher temperature engine operating conditions with three-way catalysis to reduce NOx to nitrogen and water. Another aftertreatment device used in diesel engine application is a diesel particulate filter. Diesel particulate filters trap soot and particulate matter for subsequent purge during periodic high temperature regeneration events.

Other aftertreatment devices treat the exhaust gas flow, including NOx emissions. Three-way catalysts (TWC) are utilized particularly in gasoline stoichiometric exhaust gas feedstream aftertreatment applications. During stoichiometric and rich engine operations, little to no oxygen is present in the exhaust gas feedstream thereby permitting a greater than 99% reduction of NOx emissions to nitrogen (N₂) and oxygen in the TWC. During lean engine operation, oxygen presence in the exhaust gas feedstream inhibits NOx reduction in the TWC, resulting in NOx breakthrough and requiring additional aftertreatment devices to reduce the NOx emissions, such as the SCR and NOx traps devices described herein above.

Lean exhaust gas aftertreatment systems including multiple lean exhaust gas aftertreatment devices are disadvantaged by requiring additional packaging space, thermal inefficiencies accompanying the additional surface area for thermal dissipation, and engine torque losses attributable to added back pressure. Therefore, it would be advantageous to reduce the number of aftertreatment devices in the aftertreatment system by removing excess oxygen in the exhaust gas feedstream thereby permitting stoichiometric aftertreatment of the exhaust gas feedstream.

### SUMMARY

An internal combustion engine operates at a lean air/fuel ratio and is fluidly connected to an exhaust aftertreatment system including an oxygen separator device fluidly connected upstream of a three-way catalytic converter.

### BRIEF DESCRIPTION OF THE DRAWINGS

One or more embodiments will now be described, by way of example, with reference to the accompanying drawings, in which:

FIG. 1 is a schematic drawing of an exemplary engine system and aftertreatment system, in accordance with the present disclosure;

FIG. 2 shows a first embodiment of an oxygen separator element, in accordance with the present disclosure;

FIGS. 3A and 3B show second and third embodiments of an oxygen separator element including a dense membrane, in accordance with the present disclosure;

FIG. 4 illustrates a porous membrane in the oxygen separator device arranged in a planar shaped configuration, in accordance with the present disclosure;

FIG. 5 illustrates the porous membrane in the oxygen separator device arranged in a cylindrical shaped configuration, in accordance with the present disclosure;

FIG. 6 illustrates a dense membrane in the oxygen separator device arranged in a planar shaped configuration, in accordance with the present disclosure; and

FIG. 7 illustrates the dense membrane in the oxygen separator device arranged in a cylindrical shaped configuration, in accordance with the present disclosure.

### DETAILED DESCRIPTION

Referring now to the drawings, wherein the showings are for the purpose of illustrating certain exemplary embodiments only and not for the purpose of limiting the same, FIG. 1 is a schematic drawing of an exemplary engine system schematically including an exemplary lean burn internal combustion engine 10, an accompanying control module 5, and an exhaust aftertreatment system 70 including an oxygen separator device 48 fluidly connected upstream of a three-way catalytic converter 50 that have been constructed in accordance with embodiments of the disclosure. In one embodiment, the oxygen separator device 48 is electrically connected to an electrical energy storage device 55. Like numerals refer to like elements in the embodiments. The exemplary engine 10 is operative at an air/fuel ratio that is primarily lean of stoichiometry, and may operate in one or more of a plurality of combustion modes, including a controlled auto-ignition combustion mode, a homogeneous spark-ignition combustion mode, a stratified-charge spark-ignition combustion mode, and a compression-ignition mode. The disclosure can be applied to various combustion cycles and internal combustion engine systems including homogeneous-charge compression-ignition, diesel, pre-mixed charge compression ignition, and stratified charge spark ignition direct-injection engine systems.

The exemplary engine 10 includes a multi-cylinder four-stroke internal combustion engine having reciprocating pistons slidably movable in cylinders which define variable volume combustion chambers. Each piston is connected to a rotating crankshaft by which their linear reciprocating motion is translated to rotational motion. An air intake system provides intake air to an intake manifold which directs and distributes air into an intake runner to each combustion chamber. The air intake system includes airflow ductwork and devices for monitoring and controlling the air flow. The air intake devices preferably include a mass airflow sensor for monitoring mass airflow and intake air temperature. A throttle valve preferably includes an electronically controlled device which controls air flow to the engine in response to a control signal from the control module 5. A pressure sensor in the intake manifold is adapted to monitor manifold absolute pressure and barometric pressure. An exhaust entrainment system preferably including an exhaust manifold 39 entrains and directs flow of an exhaust gas feedstream to the exhaust aftertreatment system 70. An external flow passage recirculates exhaust gases from engine exhaust to the intake manifold, having a flow control valve, referred to as an exhaust gas recirculation valve. The control module 5 is operative to control mass flow of exhaust gas to the intake manifold by controlling opening of the exhaust gas recirculation valve.

At least one intake valve and one exhaust valve corresponds to each cylinder and combustion chamber. There is preferably one valve actuator for each one of the intake and exhaust valves. Each intake valve can allow inflow of air and fuel to the corresponding combustion chamber when open. Each exhaust valve can allow flow of combustion by-products out of the corresponding combustion chamber to the aftertreatment system 70 when open.

The engine can include a fuel injection system, including a plurality of high-pressure fuel injectors each adapted to directly inject a mass of fuel into one of the combustion chambers, in response to a signal from the control module 5. The fuel injectors are supplied pressurized fuel from a fuel distribution system. The engine can include a spark-ignition system by which spark energy is provided to a spark plug for igniting or assisting in igniting cylinder charges in each of the combustion chambers in response to a signal from the control module 5.

The exemplary engine 10 is preferably equipped with various sensing devices for monitoring engine operation and exhaust gases. An exhaust gas sensor monitors the exhaust gas feedstream, and can include an air/fuel ratio sensor in one embodiment.

The electrical energy storage device 55 is configured to supply electric power to the oxygen separator device 48 and is electrically connected to the oxygen separator device 48 via electrical cables 7 and 8 and controlled by the control module 5. The electrical energy storage device 55 can include any electrical energy storage device(s) known in the art including electrical batteries, fuel cells, and/or capacitor system. Electric current can flow between the electrical energy storage device 55 and the oxygen separator device 48 as described herein below. The control module 5 controls transfer of electrical current from the electrical energy storage device 55 to the oxygen separator device 48 via electrical cables 7 and 8.

The control module 5 executes algorithmic code stored therein to control actuators to control engine operation, including throttle position, spark timing, fuel injection mass and timing, intake and/or exhaust valve timing and phasing, and exhaust gas recirculation valve position to control flow of recirculated exhaust gases. Valve timing and phasing may include negative valve overlap and lift of exhaust valve reopening (in an exhaust re-breathing strategy). The control module 5 is adapted to receive input signals from an operator (e.g., a throttle pedal position and a brake pedal position) to determine an operator torque request and from the sensors indicating the engine speed and intake air temperature, and coolant temperature and other ambient conditions.

Control module, module, controller, processor and similar terms mean any suitable one or various combinations of one or more Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the described functionality. The control module 5 has a set of control algorithms, including resident software program instructions and calibrations stored in memory and executed to provide the desired functions. The algorithms are preferably executed during preset loop cycles. Algorithms are executed, such as by a central processing unit, and are operable to monitor inputs from sensing devices and other networked control modules, and execute control and diagnostic routines to control operation of actuators. Loop cycles may be executed at regular intervals, for example each 3.125, 6.25, 12.5, 25 and 100 milliseconds during ongoing engine and vehicle operation. Alternatively, algorithms may be executed in response to occurrence of an event The exhaust aftertreatment system 70 includes an oxygen separator device 48 and the three-way catalytic converter 50. The oxygen separator device 48 is preferably closely coupled to the exhaust manifold 39 and serially and fluidly connected upstream of the three-way catalytic converter 50. The oxygen separator device 48 is configured to separate elemental oxygen from the exhaust gas feedstream and preferably expel it to atmosphere via an outlet port. Alternatively, the separated elemental oxygen may be recirculated to the air intake system of the engine 10. The three-way catalytic converter 50 includes at least one metallic or ceramic substrate having a washcoat including a catalytic material that oxidizes, adsorbs, desorbs, and/or reduces constituent elements in the exhaust gas feedstream.

The exhaust aftertreatment system 70 can be equipped with various sensing devices for monitoring the exhaust gas feedstream from the engine 10, including NOx and oxygen sensors signally connected to the control module 5. NOx sensors detect and quantify NOx molecules in the exhaust gas feedstream. Oxygen sensors detect and quantify free oxygen molecules in the exhaust gas feedstream. In one embodiment, temperature sensors are included in the exhaust aftertreatment system 70 and signally connected to the control module 5 to monitor temperature of the exhaust gas feedstream and/or the three-way catalytic converter 50.

During engine operation, the exemplary engine 10 generates an exhaust gas feedstream containing constituent elements that can be transformed in the aftertreatment system, including hydrocarbons (HC), carbon monoxide (CO), oxides of nitrogen (NOx), and particulate matter (PM), among others. The three-way catalytic converter 50 is configured to reduce the constituent elements contained in a stoichiometric exhaust gas feedstream. The three-way catalytic converter 50 reduces NOx to O2 and N2, and oxidizes the HC and CO simultaneously to form CO2 and water as described in the following reactions.

NOx→N2+O2 [1]

HC+O2→H2O+CO2 [2]

CO+O2→CO2 [3]

Reaction [1] describes a reaction that separates or reduces the NOx into molecular nitrogen (N2) and molecular oxygen (O2) in presence of a catalyst. Reactions [2] and [3] describe oxidation reactions that combine the incomplete products of combustion, either HC or CO, with oxygen to form complete combustion products, e.g., CO2 and water. During stoichiometric exhaust gas conditions, oxygen produced by Reaction [1] will be simultaneously consumed by Reactions [2] and [3] to oxidize the CO and HC.

However, it is apparent that in an aftertreatment system configured without the oxygen separator device 48 described herein above, reduction of NOx as described by Reaction [1] decreases in the three-way catalytic converter 50 as oxygen presence in the exhaust gas feedstream increases. Generally, chemical reactions proceed at a rate that is determined by the concentrations of the various species. A higher concentration of the reactant species and a lower concentration of the product species leads to a faster reaction rate. Lower concentration of reactants and higher concentration of products leads to a slower reaction rate. Since oxygen is a product of the Reaction [1] above, the presence of oxygen in the exhaust stream will inhibit the production of more oxygen by the reaction. Thus, oxygen presence in the exhaust gas feedstream inhibits NOx reduction as described by Reaction [1], and results in NOx breakthrough out of the exhaust aftertreatment system 70. The oxygen separator device 48 separates oxygen from the exhaust gas feedstream thereby permitting the three-way catalytic converter 50 to convert NOx to N2 and oxygen as described by Reaction [1] herein above.

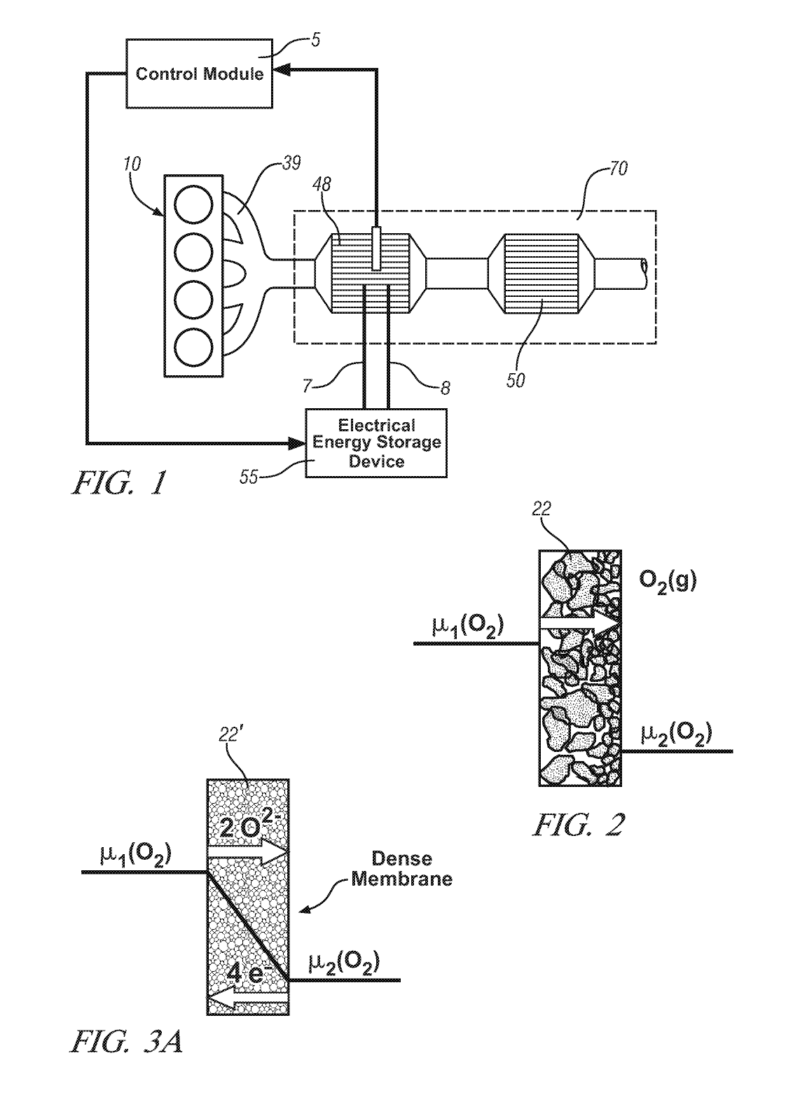

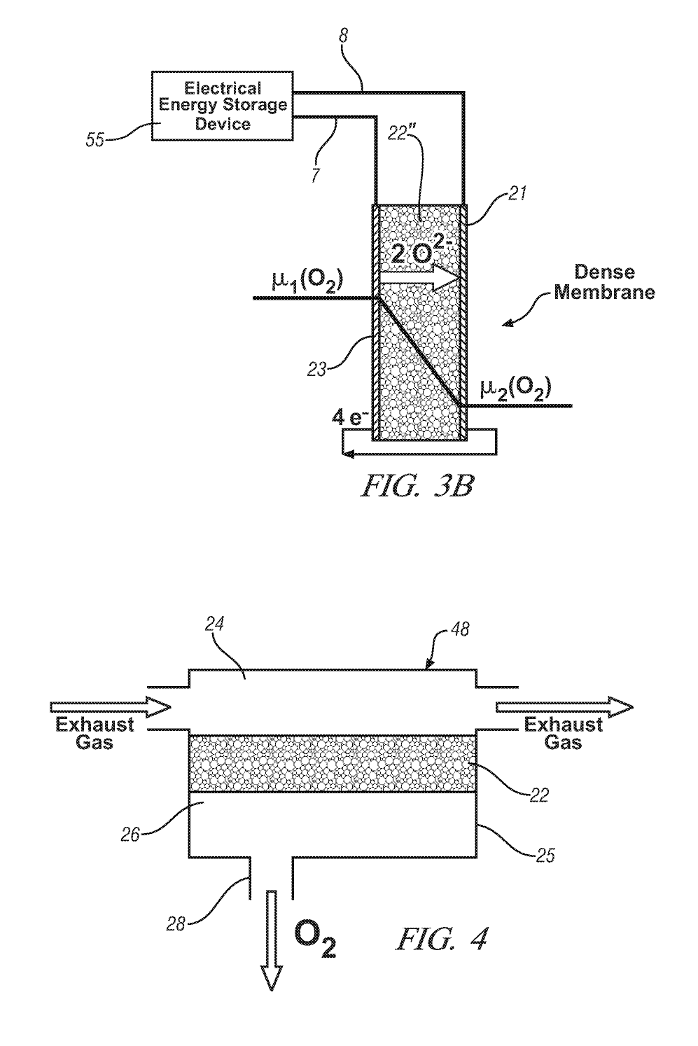

The oxygen separator device 48 includes an oxygen separator element contained in a housing module, i.e., a stainless container. The oxygen separator element is configured to selectively separate oxygen molecules contained in the exhaust gas feedstream. Embodiments of the oxygen separator element may be used consistent with the disclosure including embodiments wherein the oxygen separator element includes a porous membrane element, as illustrated in FIG. 2, and dense membrane elements, as illustrated in FIGS. 3A and 3B. The porous membrane elements have relatively higher permeability and relatively lower permselectivity compared to dense membrane elements. Oxygen transfers through the porous membrane elements as oxygen molecules while oxygen transfers through dense membrane elements as an ionic species of oxygen. The dense membrane elements can have any suitable oxygen conductivity such as, for example, conductivities in the range of about 0.01 to 2 ohm⁻¹ cm⁻¹. Multiple shape configurations of the oxygen separator element may be included in the oxygen separator device 48, including planar and cylindrical shaped configurations as described herein below and illustrated in FIGS. 4-7. Additionally, the oxygen separator element can have any suitable thickness, preferably a range between about 10 to 1000 micrometers.

FIG. 2 illustrates an exemplary first embodiment of the oxygen separator element 22 useable to selectively separate oxygen molecules. The first embodiment of the oxygen separator element 22 is a porous membrane element. The first embodiment of the oxygen separator element 22 is preferably constructed from ceramic silicon carbide (SiC) substrate and coated with one of alumina, silica, and zeolite. As FIG. 2 shows, the first embodiment of the oxygen separator element 22 may include multiple asymmetrically structured porous membrane elements. The first embodiment of the oxygen separator element 22 transfers oxygen molecules (O₂) by diffusion, viscous flow and surface diffusion from a first side to a second side of the porous membrane element, wherein the first side is in contact with the exhaust gas feedstream. A dusty-gas-model can be used to estimate the rates of diffusion, viscous flow and surface diffusion to quantitatively estimate oxygen transfer through the porous membrane element. To determine appropriate surface area of size thereof, it is appreciated that pore sizes of the porous membrane element are predetermined based upon preferred oxygen permeability rates. In operation, oxygen permeates through the porous membrane element when a positive pressure differential exists between the first side of the porous membrane element and the second side, wherein the second side corresponds to a lower pressure and the first side corresponds to a higher pressure.

FIGS. 3A and 3B illustrate second and third exemplary embodiments of the oxygen separator element 22′ and 22″ useable to selectively separate oxygen molecules. The second and third embodiments of the oxygen separator element 22′ and 22″ are dense membrane elements including substrates coated with at least one of zirconia and a perovskite material. The second embodiment of the oxygen separator element 22′ is a mixed ion-electron conductor dense membrane element and is depicted in FIG. 3A. The third embodiment of the oxygen separator element 22″ is an ion conductor solid electrolyte type dense membrane element 22″ and is depicted in FIG. 3B. The mixed ion-electron conductor membrane has relatively high ionic conductivities and relatively high electric conductivities, while the ion conductor solid electrolyte membrane has relatively high ionic conductivities and relatively low electric conductivities. Thus, the ion conductor solid electrolyte membrane 22″ is electrically coupled to electrodes including an anode 21 coupled to the first side of the membrane and a cathode 23 coupled to the second side of the membrane. The anode and cathode electrodes 21 and 23 are connected to the electrical energy storage device 55 via the electrical cables 7 and 8. Electric potential between the anode 21 and cathode 23 attracts and permeates ionic species of oxygen molecules through the ion conductor solid electrolyte membrane. Electrical energy from the electrical energy storage device 55 drives the ion conduction process and thus enables control of oxygen permeation through the ion conductor solid electrolyte membrane 22″. The second and third embodiments of the oxygen separator element 22′ and 22″ do not require a positive pressure differential to effect oxygen separation.

The second and third embodiments of the oxygen separator element 22′ and 22″ include substrates composed of one of multiple materials including polymer and ceramic material. Polymer substrates preferably operate at temperatures between 200° C. and 250° C., while ceramic substrates operate at relatively higher temperatures, e.g., up to 800° C. The substrates may be coated with at least one of zirconia and perovskite materials such as Sr/Mg-doped lanthan gallat (LSGM). Zirconia may be stabilized with yttria or scandia.

Any suitable electrode materials having high electronic conductivity as well as high oxygen transport properties may be used for the anode 21 and the cathode 23. For example, silver, platinum, lanthanum-strontium-magnesium (LSM) oxide, lanthanum-strontium-cobalt (LSC) oxide, may be used. LSM oxides have relatively higher conductivities and thermal compatibility than the LSC oxides. The anode 21 and the cathode 23 can have any suitable thickness. The anode 21 and the cathode 23 are operative at any suitable electric current density, in one embodiment ranging between 0.05 and 2 amperes/cm². In one embodiment, the anode 21 and the cathode 23 are porous electrode layers.

FIGS. 4 and 5 show planar and cylindrical shaped configurations, respectively, of the oxygen separator device 48 the including the first embodiment of the oxygen separator element 22. A first flow passage 24 is configured to permit exhaust gas to flow through the oxygen separator device 48 whereby oxygen molecules may permeate by diffusion, viscous flow and surface diffusion through the first embodiment of the oxygen separator element 22 and into a second flow passage 26. The second flow passage 26 is preferably connected to an outlet port 28 configured to permit oxygen to flow out of the oxygen separator device 48.

The oxygen separator device 48 depicted in FIG. 4 includes a housing 25 having the first embodiment of the oxygen separator element 22 arranged in a planar manner and separating the first flow passage 24 and the second flow passage 26. The first flow passage 24 is preferably closely coupled to the exhaust manifold 39 and entrails the exhaust gas feedstream from the engine 10. The first embodiment of the oxygen separator element 22 separates the first flow passage 24 from the second flow passage 26 in a manner that prohibits exhaust gas from flowing directly from the first flow passage 24 to the second flow passage 26. In operation, oxygen permeates through the oxygen separator element 22 when a positive pressure differential exists between a first side of the oxygen separator element 22 associated with the first flow passage 24 and the second side associated with the second flow passage 26, wherein the second side corresponds to a lower pressure and the first side corresponds to a higher pressure.

The oxygen separator device 48 depicted in FIG. 4 includes a housing 25 having the first embodiment of the oxygen separator element 22 arranged in a cylindrical configuration and separating the first flow passage 24 and the second flow passage 26. The housing 25 connects to the first embodiment of the oxygen separator element 22 preferably by elongated members or spokes arranged to separate and hold the first embodiment of the oxygen separator element 22 from the housing 25 to allow oxygen flow through the oxygen separator element 22 to the second flow passage 26 and the outlet port 28.

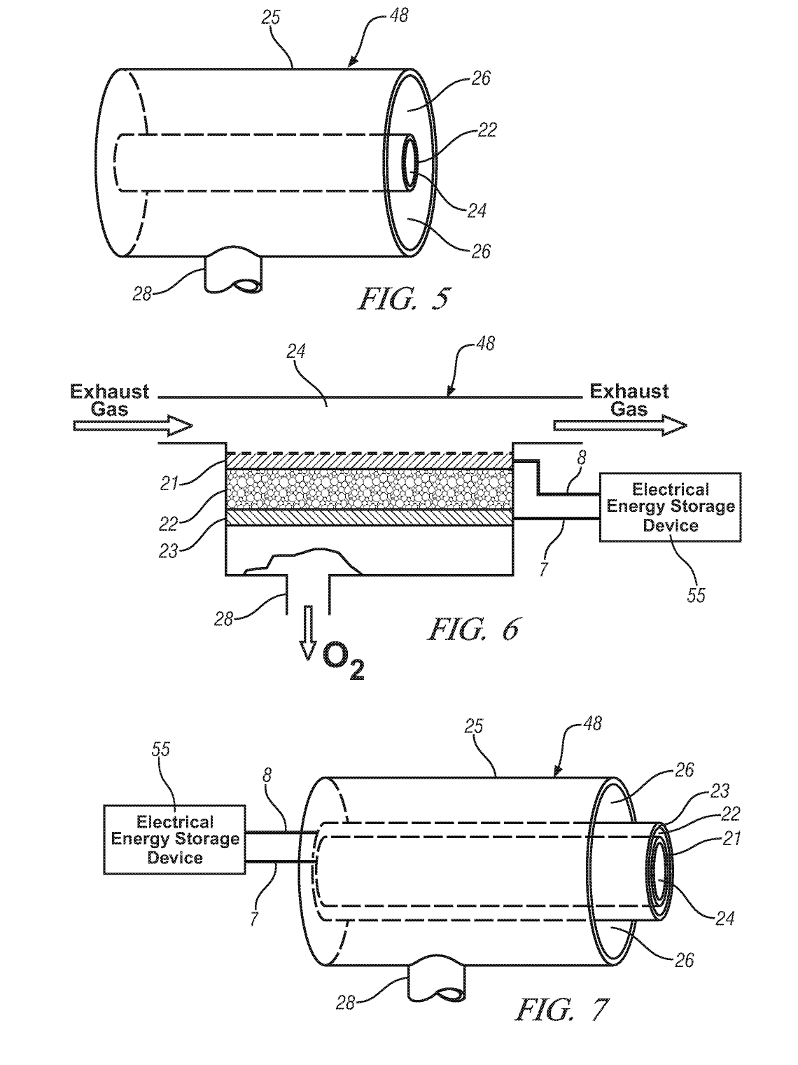

FIGS. 6 and 7 show planar and cylindrical configurations, respectively, of oxygen separator device 48 including the third embodiment of the oxygen separator element 22″ configured to include ion conductor solid electrolyte membrane and the anode and cathode electrodes 21 and 23 in the oxygen separator device 48. The oxygen separator device 48 includes the third embodiment of the oxygen separator element 22″disposed between electrodes including the anode 21 and the cathode 23. The anode and cathode electrodes 21 and 23 are positioned at opposite sides of the third embodiment of the oxygen separator element 22″enabling electrical voltage to be applied across a surface of the third embodiment of the oxygen separator element 22″. Electrodes such as the electrical cables 7 and 8 may be connected to an electric power source such as the electrical energy storage device 55 to transfer electric current to the anode and cathode electrodes 21 and 23. A first flow passage 24 is configured to permit exhaust gas to flow through the oxygen separator device 48 whereby oxygen molecules may permeate the third embodiment of the oxygen separator element 22″ and flows into a second flow passage 26. An outlet port 28 permits oxygen molecules to exit the oxygen separator device 48.

The planar configuration of the oxygen separator device 48 depicted in FIG. 6 includes the first flow passage 24 and the second flow passage 26 arranged in a housing 25. The oxygen separator device 48 separates the first flow passage 24 from the second flow passage 26 in a manner configured to prohibit exhaust gas from flowing from the first flow passage 24 to the second flow passage 26.

The cylindrical configuration of the oxygen separator device 48 depicted in FIG. 7 includes the second flow passage 26 arranged between the housing 25 of the oxygen separator device 48 and the third embodiment of the oxygen separator element 22″. The housing 25 connects the third embodiment of the oxygen separator element 22″ preferably by elongated members or spokes arranged to separate and hold the third embodiment of the oxygen separator element 22″ from the housing 25 to allow oxygen flow between the housing 25 and the third embodiment of the oxygen separator element 22″.

During lean engine operation, the engine 10 generates an exhaust gas feedstream including NOx emissions and oxygen. The oxygen separator device 48 separates the oxygen molecules from the exhaust gas feedstream, and the three-way catalytic converter 50 reduces NOx emissions in the exhaust gas feedstream to nitrogen and oxygen. In embodiments of the oxygen separator device 48 that include the ion conductor solid electrolyte membrane 22″, the control module 5 controls the electrical energy storage device 55 to transfer electrical energy to the membrane 22″ thus enabling oxygen separation from the exhaust gas feedstream.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Apparatus, comprising:
an internal combustion engine configured to operate at a lean air/fuel ratio, the engine fluidly connected to an exhaust aftertreatment system comprising an oxygen separator device fluidly connected upstream of a three-way catalytic converter.

2. The apparatus of claim 1, wherein the oxygen separator device comprises:
an oxygen separator element configured to separate the oxygen from the exhaust gas feedstream.

3. The apparatus of claim 2, wherein the oxygen separator element comprises a porous membrane element comprising silicon carbide coated with at least one of alumina, silica, and zeolite.

4. The apparatus of claim 3, wherein the oxygen separator element comprises multiple asymmetrically structured porous membrane elements.

5. The apparatus of claim 4, wherein the oxygen separator element separates oxygen from the exhaust gas feedstream using a diffusion process.

6. The apparatus of claim 4, wherein the oxygen separator separates oxygen from the exhaust gas feedstream using a viscous flow process.

7. The apparatus of claim 4, wherein the oxygen separator element separates oxygen from the exhaust gas feedstream using a surface diffusion process.

8. The apparatus of claim 2, wherein the oxygen separator element comprises a dense membrane element comprising silicon carbide and coated with at least one of zirconia and a perovskite material.

9. The apparatus of claim 8, wherein the dense membrane element is a mixed ion-electron conductor membrane.

10. The apparatus of claim 8, wherein the dense membrane element is an ion conductor solid electrolyte membrane.

12. The apparatus of claim 10, wherein the ion conductor solid electrolyte membrane is electrically coupled to an anode and a cathode electrode, wherein the anode and the cathode electrodes are electrically connected to an electrical energy storage device.

13. The apparatus of claim 2, wherein the oxygen separator device includes a housing having the oxygen separator element arranged in a planar manner to separate a first flow passage and a second flow passage.

14. The apparatus of claim 2, wherein the oxygen separator device includes a housing having the oxygen separator element arranged in a cylindrical manner to separate a first flow passage and a second flow passage.

15. Method for reducing NOx emissions from an internal combustion engine, the method comprising:
selectively operating the engine lean of stoichiometry;
separating oxygen molecules from an exhaust gas feedstream upstream from a three-way catalytic converter during lean engine operation; and
reducing NOx emissions in the exhaust gas feedstream using the three-way catalytic converter.

16. The method of claim 15, wherein separating oxygen molecules from the exhaust gas feedstream comprises:
diffusing oxygen molecules through a porous membrane element of an oxygen separator device from the exhaust gas feedstream.

17. The method of claim 15, wherein separating oxygen molecules from the exhaust gas feedstream comprises:
applying an electric potential across a dense solid membrane element; and
permeating ionic species of oxygen molecules through the dense solid membrane element from the exhaust gas feedstream.

18. The method of claim 17, wherein the dense solid membrane element is a mixed ion-electron conductor membrane.

19. The method of claim 17, wherein the dense solid membrane element is an ion conductor solid electrolyte membrane.
